(19) United States
(12) Patent Application Publication
(10) Pub. No.: US 2005/0023509 A1
(43) Pub. Date: Feb. 3, 2005

(54) Single layer fireblocking fabric for a mattress or mattress set and process to fireblock same

(76) Inventors: Laurence N. Bascom, Amelia, VA (US); Herman Hans Forsten, Williamsburg, VA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/630,618

(22) Filed: Jul. 29, 2003

(51) Int. Cl. C09K 21/00

(52) U.S. Cl. 252/608

(57) ABSTRACT

This invention relates to a single layer nonwoven fabric useful as a fireblocking component for mattresses, and a mattress or mattress set comprising the nonwoven fabric, and a process for fireblocking said mattress and mattress set; the nonwoven fabric comprising at least 0.5 ounces per square yard (17 grams per square meter) of a cellulose fiber that retains at least 10 percent of its fiber weight when heated in air to 700° C. at a rate of 20 degrees C. per minute, and at least 0.5 ounces per square yard (17 grams per square meter) of an organic fiber that retains 90 percent of its fiber weight when heated in air to 500° C. at a rate of 20 degrees C. per minute, the fabric having a basis weight having at least 2.5 ounces per square yard (85 grams per square meter), a density of at least 0.16 gram/cm³, and an air permeability of 70 meters/min (225 ft/min) or less.

### BACKGROUND OF THE INVENTION

1. Field of the Invention

This invention relates to a single layer nonwoven fabric useful as a fireblocking component for mattresses and a mattress or mattress set comprising the nonwoven fabric, and a process for fireblocking said mattress and mattress set.

2. Description of Related Art

The State of California has led the drive to regulate and reduce the flammability of mattresses and mattress sets in an attempt to reduce the number of lives lost in household, hotel, and institutional fires. In particular, the Bureau of Home Furnishings and Thermal Insulation of the Department of Consumer Affairs of the State of California issued Technical Bulletin 603 “Requirements and Test Procedure for Resistance of a Residential Mattress/Box Spring Set to a Large Open-Flame” to quantify the flammability performance of mattress sets.

Mattresses normally contain a mattress core covered by cushioning material or batting that is in turn covered with an outer fabric ticking. Most cushioning material or batting is made from foam or fiber materials that will burn when exposed to an open flame. One useful method of fire blocking foam cushions, particularly airplane seats, is disclosed in U.S. Pat. No. 4,750,443 to Blaustein, et al., wherein three to seven layers of flame resistant fabrics are used underneath the covering fabric of the seat to encase the foam. To the degree required per the aircraft seat flammability test method, these fire blocked cushions withstand a flame jet impinging on the cushion and prevent the entire cushion from being engulfed by the flame or continuing to burn after the flame jet is removed. When applied to mattresses, the use of multiple fire blocking layers underneath the ticking can add stiffness or restrain the give of the mattress core, affecting overall comfort.

U.S. Pat. Nos. 6,132,476; 6,547,835, and 5,609,950 disclose fabric blends of inherently flame resistant fibers and cellulosic fibers having increased flame resistance; the fabric can contain an additional fire retardant that is added, for example, as an additive in a dyeing step. Because of the low content of inorganic material the flame resistant cellulose fiber disclosed in these references does not retain an adequate percentage of their fiber weight when exposed to high temperatures.

What is needed therefore, is a single fabric layer that is suitable for fireblocking a mattress.

### SUMMARY OF THE INVENTION

This invention relates to a single layer nonwoven fabric useful as a fireblocking component for mattresses, comprising at least 0.5 ounces per square yard (17 grams per square meter) of a cellulose fiber that retains at least 10 percent of its fiber weight when heated in air to 700 C at a rate of 20 degrees C. per minute, and at least 0.5 ounces per square yard (17 grams per square meter) of an organic fiber that retains 90 percent of its fiber weight when heated in air to 500° C. at a rate of 20 degrees C. per minute, the fabric having a basis weight having at least 2.5 ounces per square yard (85 grams per square meter), a density of at least 0.16 gram/cm³, and an air permeability of 70 meters/min (225 ft/min) or less.

This invention also relates to a fireblocked mattress and a method of fireblocking mattresses and mattress sets, said mattress comprising a mattress core, a panel comprising a single layer nonwoven fireblocking fabric, and ticking having a basis weight in the range of 2 to 8 ounces per square yard (68 to 271 grams per square meter), the single layer nonwoven fabric comprising at least 0.5 ounces per square yard (17 grams per square meter) of a cellulose fiber that retains at least 10 percent of its fiber weight when heated in air to 700 C at a rate of 20 degrees C. per minute, and at least 0.5 ounces per square yard (17 grams per meter) of an organic fiber that retains 90 percent of its fiber weight when heated in air to 500° C. at a rate of 20 degrees C. per minute, the fabric having a basis weight having at least 2.5 ounces per square yard (85 grams per square meter), a density of at least 0.16 gram/cm³, and an air permeability of 70 meters/min (225 ft/min) or less.

### BRIEF DESCRIPTION OF THE DRAWINGS

FIG. 1 illustrates, in a simplified manner, the arrangement of burners, the mattress and foundation used to test the burn performance of a mattress and mattress set of this invention.

FIG. 2 illustrates, in a simplified manner, the offset of the arrangement of burners used to burn the mattress and mattress set of this invention.

### DETAILS OF THE INVENTION

This invention is directed to a single layer nonwoven fabric that is useful as a fireblocking component for mattresses, and a process for incorporating that single layer nonwoven fabric to fireblock a mattress. The single layer nonwoven fabric is comprised of at least 0.5 ounces per square yard (17 grams per square meter) of a cellulose fiber that retains at least 10 percent of its fiber weight when heated in air to 700 C at a rate of 20 degrees C. per minute, and at least 0.5 ounces per square yard (17 grams per square meter) of an organic fiber that retains 90 percent of its fiber weight when heated in air to 500° C. at a rate of 20 degrees C. per minute. The nonwoven fireblocking fabric used in this invention has a basis weight of at least 2.5 ounces per square yard (85 grams per square meter). Such single layer nonwoven fabrics having basis weights of less than that amount do not provide adequate fireblocking performance. The maximum practical basis weight of the nonwoven fireblocking fabric of this invention is in the range of 7 ounces per square yard. Heavier weight fabrics still provide protection, however, with additional basis weight there is little improvement in fire retarding performance. The single layer fireblocking fabric further has a density of at least 0.16 grams per cubic centimeter and an air permeability of 225 ft/min (70 meters/min) or less as measured by air permeability standard ASTM D-737 “Air Permeability of Textile Fabric”. Fabrics having a lower density or a higher permeability are believed to be too porous or open to function adequately as a fireblocking layer in a mattress. Nonwoven fabrics having this composition, basis weight, and permeability can be used as the sole fireblocking component for a mattress or a mattress set comprising a mattress and foundation.

The nonwoven fabric of this invention contains at least 0.5 ounces per square yard (17 grams per square meter) of a char-forming cellulose fiber. By char-forming, it is meant the cellulose fiber retains at least 10 percent of its weight when heated in air to 700° C. at a rate of 20 degrees C. per minute. Such cellulose fibers preferably have 10% inorganic compounds incorporated into the fibers. Such fibers, and methods for making such fibers, are generally disclosed in U.S. Pat. No. 3,565,749 and British Pat. No. GB 1,064,271. A preferred char-forming cellulose fiber for this invention is a viscose fiber containing silicon dioxide in the form of a polysilicic acid with aluminum silicate sites. Such fibers, and methods for making such fibers are generally disclosed in U.S. Pat. Nos. 5,417,752 and PCT Pat. Appl. WO 9217629. Viscose fiber containing silicic acid is sold under the trademark Visil® by Sateri Oy Company of Finland. The char-forming fibers of this invention, when incorporated into the nonwoven fabric, provide adequate fireblocking performance without the need for the fabric to be treated with additional flame-retardant additives or topically-applied flame retardant compounds.

The single layer nonwoven fabric contains a least 0.5 ounces per square yard of an organic fiber that retains 90 percent of its fiber weight when heated in air to 500° C. at a rate of 20 degrees C. per minute. Such organic fibers are normally flame resistant, meaning the fiber or a fabric made from the fiber has a Limiting Oxygen Index (LOI) of greater than the range of 23 to 26%, that is, the fiber or fabric will not support a flame in air. The preferred fibers do not excessively shrink when exposed to a flame, that is, the length of the fiber will not significantly shorten when exposed to flame. Fabrics containing 0.5 ounces per square yard (17 grams per square meter) of an organic fiber that retains 90 percent of its fiber weight when heated in air to 500° C. at a rate of 20 degrees C. per minute tend to have limited amount of cracks and openings when burned by an impinging flame.

The preferred organic fiber comprises para-aramid polymer. As used herein, “aramid” is meant a polyamide wherein at least 85% of the amide (—CONH—) linkages are attached directly to two aromatic rings. Additives can be used with the aramid. In fact, it has been found that up to as much as 10 percent, by weight, of other polymeric material can be blended with the aramid or that copolymers can be used having as much as 10 percent of other diamine substituted for the diamine of the aramid or as much as 10 percent of other diacid chloride substituted for the diacid chloride of the aramid. In the practice of this invention, the preferred para-aramid is poly(paraphenylene terephthalamide).

Methods for making para-aramid fibers useful in this invention are generally disclosed in, for example, U.S. Pat. Nos. 3,869,430; 3,869,429; and 3,767,756. Such aromatic polyamide organic fibers and various forms of these fibers are available from DuPont Company, Wilmington, Del. under the trademark Kevlar®D fibers.

Nonwoven fabrics of this invention can be made by conventional nonwoven sheet forming processes, including processes for making air-laid nonwovens or wet-laid nonwovens, and such formed sheets can be consolidated into fabrics via spunlacing, hydrolacing, needlepunching, or other processes which can generate a nonwoven sheet. The spunlaced processes disclosed in U.S. Pat. Nos. 3,508,308 and 3,797,074; and the needlepunching processes disclosed in U.S. Pat. No. 2,910,763 and U.S. Pat. No. 3,684,284 are examples of methods well-known in the art that are useful in the manufacture of the nonwoven fabric of this invention. The preferred nonwoven fabrics of this invention are air-laid spunlaced or hydrolaced nonwovens where high pressure water jets are used to entangle fibers into a cohesive sheet.

The nonwoven fabric can include, in addition, an off gassing material that releases a flame suppressing gas when burned. The preferred off gassing material are fibers made from halogen-containing polymers, such as modacrylic fiber or polyvinylchloride fibers. These polymers release chlorine-containing gases when burned. Up to 4 ounces per square yard (136 grams per square meter) of such materials can be added to the single layer nonwoven fabric. Useful modacrylic fibers include, but are not limited to, those disclosed in U.S. Pat. No. 5,506,042 The fireblocking nonwoven fabric may be disposed on a mattress directly beneath the fabric ticking. Preferably, such ticking is a woven or knitted fabric having a basis weight in the range of 2 to 8 ounces per square yard, which provides the mattress with a luxurious look and aesthetic appeal. It is not required that the ticking be fire retardant or that any stitching or quilting of the ticking be done with fire resistant thread. Assuming the fireblocking component completely covers the remaining flammable materials of the mattress, when exposed to flame, the ticking will quickly burn away leaving a mattress with fireblocked internals.

The fireblocking nonwoven fabric of the this invention is useful to fire block the panels and/or the borders of the mattress, and different amounts of cushioning material may be used in the borders versus the panel of the mattress. To totally fire block the mattress the fire blocking should be incorporated into all panels and borders of the mattress. This allows the mattress to be turned by the owner so that both sides of the mattress can be used, without losing any of the fire blocking qualities.

The fireblocking nonwoven fabric can also be used to fire block a mattress set of a mattress and a mattress foundation. Foundations, such as box springs, are not normally turned by the owners and do not have to be completely fire blocked but generally are only required to have fire blocking on the borders and optionally on the face or panel of the foundation, which is normally in contact with the mattress. This foundation panel in contact with the mattress is generally shielded from flame so the material used in the panel does not typically have to have the same degree of fire blocking as say, the panel of the mattress. Further, the mattress foundation may not have a large degree of cushioning material in the border and/or the panel. However, the single layer fire blocking fabric will normally be used underneath the outer ticking in the mattress foundation borders.

This invention is further directed to a process for fireblocking a mattress core by providing the mattress core with a single layer nonwoven fabric useful as a fireblocking component for mattresses, the fabric comprising at least 0.5 ounces per square yard (17 grams per square meter) of a cellulose fiber that retains at least 10 percent of its fiber weight when heated in air to 700° C. at a rate of 20 degrees C. per minute, and at least 0.5 ounces per square yard (17 grams per meter) of an organic fiber that retains 90 percent of its fiber weight when heated in air to 500° C. at a rate of 20 degrees C. per minute, the fabric having a basis weight having at least 2.5 ounces per square yard (85 grams per square meter). The nonwoven fabric may also include an off gassing material in the amount of up to 4 ounces per square yard (136 grams per square meter) that releases a flame suppressing gas when burned.

One method of fireblocking the mattress core is by fully covering the panels and borders of the mattress core underneath the ticking material to encapsulate the mattress. This insures the mattress will be fireblocked regardless of which panel or border is exposed to the flame.

### TEST METHODS

Mattress Burn Performance

The Bureau of Home Furnishings and Thermal Insulation of the Department of Consumer Affairs of the State of California (3485 Orange Grove Avenue, North Highlands, Calif. 95660-5595, USA) published Technical Bulletin 603 “Requirements and Test Procedure for Resistance of a Residential Mattress/Box Spring Set to a Large Open-Flame” dated February 2003 to quantify the flammability performance of mattress sets. This protocol provides a means of determining the burning behavior of mattress/foundation sets by measuring specific fire test responses when the mattress plus foundation are exposed to a specified flaming ignition source under well-ventilated conditions. It is based on the National Institute of Standards and Technology Publication titled “Protocol of Testing Mattress/Foundation Sets Using a Pair of Gas Burners” dated February 2003.

Test data are obtained that describe the burning during and subsequent to the application of a specific pair of gas burners from the point of ignition until (1) all burning of the sleep set has stopped, (2) a period of one hour has elapsed, or (3) flashover of the test room appears inevitable. The rate of heat release from the burning test specimen (the energy generated by the fire) is measured by oxygen consumption calorimetry. A discussion of the principles, limitations, and requisite instrumentation are found in ASTM E 1590 “Standard Test Method of Fire Testing of Mattresses”. Terminology associated with the testing is defined in ASTM E 176 “Standard Terminology of Fire Standards”.

In general, the test protocal utilizes a pair of propane burners, designed to mimic the heat flux levels and durations imposed on a mattress and foundation by burning bedclothes. The burners impose differing fluxes for differing times on the mattress top and the side of the mattress/foundation. During and subsequent to this exposure, measurements are made of the time-dependent heat release rate from the test specimen.

The mattress/foundation is placed on top of a short bed frame that sits on a catch surface. During the testing, the smoke plume is caught by a hood that is instrumented to measure heat release rate. For practicality, twin-sized mattresses and foundations are tested. After ignition by the burners, the specimen is allowed to burn freely under well-ventilated conditions.

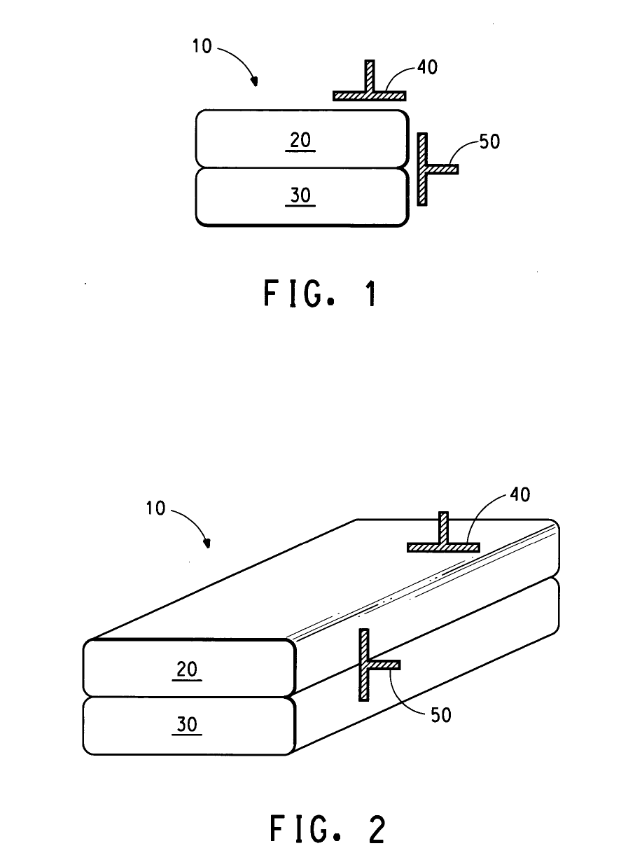

A representative illustration of the general locations of the gas burners, not drawn to scale, is shown in FIG. 1. Test specimen 10 includes a mattress 20 is placed on foundation 30 with T-shaped burners 40 and 50 set to burn the specimen. Burner 40 impinges flames on the top surface of the mattress and is set 39 mm from the surface of the mattress. The second burner 50 impinges flames vertically on the side of the mattress/foundation combination and is set 42 mm from the side of the specimen. The side burner and the top burner are not set at the same place along the length of the specimen but are offset from on another along the length approximately 18 to 20 cm as generally illustrated in FIG. 3. The burners are specially constructed and aligned per the test method.

The test specimen is conditioned for 24 hours prior to the testing at an ambient temperature of above 12 Celsius (54 Fahrenheit) and a relative humidity of less than 70 percent. The test specimen of mattress and foundation is centered on each other and the frame and catch surface. If the mattress is 1 to 2 cm narrower than the foundation the mattress may be shifted until the sides of the mattress and foundation are aligned vertically. The burners are aligned and spaced from the specimen per the standard. Data recording and logging devices are turned on at least one minute prior to ignition. The burners are ignited and the top burner is allowed to burn for 70 seconds while the side burner is allowed to burn for 50 seconds (if possible) and then they are removed from the area. Data collection continues until all signs of burning and smoldering have ceased or until one hour has elapsed.

ThermoGravametric Analysis

The fibers used in this invention retain a portion of their fiber weight when heated to high temperature at a specific heating rate. This fiber weight was measured using a Model 2950 Thermogravimetric Analyzer (TGA) available from TA Instruments (a division of Waters Corporation) of Newark, Del. The TGA gives a scan of sample weight loss versus increasing temperature. Using the TA Universal Analysis program, percent weight loss can be measured at any recorded temperature. The program profile consists of equilibrating the sample at 50 degrees C.; ramping the temperature at from 10 or 20 degrees C. per minute from 50 to 1000 degrees C.; using air as the gas, supplied at 10 ml/minute; and using a is a 500 microliter ceramic cup (PN 952018.910) sample container.

The testing procedure is as follows. The TGA was programmed using the TGA screen on the TA Systems 2900 Controller. The sample ID was entered and the planned temperature ramp program of 20 degrees per minute selected. The empty sample cup was tared using the tare function of the instrument. The fiber sample was cut into approximately 1/16″ (0.16 cm) lengths and the sample cup was loosely filled with the sample. The sample weight should be in the range of 10 to 50 mg. The TGA has a balance, therefore the exact weight does not have to be determined beforehand. None of the sample should be outside the cup. The filled sample cup was loaded onto the balance wire making sure the thermocouple is close to the top edge of the cup but not touching it. The furnace is raised over the cup and the TGA is started. Once the program is complete, the TGA will automatically lower the furnace, remove the sample cup, and go into a cool down mode. The TA Systems 2900 Universal Analysis program is then used to analyze and produce the TGA scan for percent weight loss over the range of temperatures.

Air Permeability

Air permeability was measured according to standard ASTM D-737 “Air Permeability of Textile Fabric”.

### EXAMPLE

Four sleep sets, each comprised of a mattress and foundation, were made using typical mattress and box spring construction techniques, each set only differing in the type and basis weight of fireblocking fabric used. The mattress core was a standard steel coil construction covered with a fiber pad and a 0.5 inch (1.25 centimeter) foam sheet. The foundation was a standard steel coil and wood box construction. All mattresses were a tight (smooth) top style. Table 1 lists the composition and basis weight of the fireblocking fabric used in the four mattresses.

TABLE 1

| | | | | Air |
|---|---|---|---|---|
| | | Basis wt. | | Permeability |
| Item | | oz/yd² | Density | ft/min |
| No. | Composition | (g/m²) | g/cm³ | (m/min) |
| 1 | 50% Kevlar ®/50% Visil ® | 2.5 (85) | 0.18 | 215 (66) |
| 2 | 33% Kevlar ®/67% Visil ® | 3.0 (102) | 0.22 | 146 (45) |
| 3 | 25% Kevlar ®/75% Visil ® | 4.0 (136) | 0.28 | 65 (20) |
| 4 | 25% Kevlar ®/75% Visil ® | 3.0 (102) | 0.23 | 159 (48) |

Panel material for the mattresses was assembled by quilting together with standard polyester thread the following components in the order: 3.5 oz/yd² woven(?) polyester ticking fabric, a single layer fire blocking fabric from Table 2, approximately 1″ polyester batting having an areal density of 0.75 oz/yd², 1″ polyurethane foam sheet, 0.5″ polyurethane foam sheet, and a nonwoven backing sheet of approximately 1 oz/yd². The panel material was used to cover both sides (top and bottom) of the two-sided mattresses.

Border material was assembled in a separate operation by quilting together with standard polyester thread the following components in the order: 3.5 oz/yd² woven(?) polyester ticking fabric, the same fire blocking fabric selected from Table 2 (same as used for the panel), 0.187″ polyurethane foam and a nonwoven backing sheet of approximately 1 oz/yd². The border material was used to cover all four vertical sides of the mattresses.

The border material was also used on the four vertical sides of the foundation employing a 2 inch (5.1 centimeter) continental or waterfall design on the upper edge of the foundation, a design in which the border material is folded over the upper edge and extends onto the foundation top panel.

The foundation top panel area within the continental edge was covered with a 3 oz/yd² (102 g/m²) of spunlaced nonwoven fabric (having a composition of 50% Kevlar® and 50% Visil®) under a standard non-skid pad. All border and panel composite material seams were sewed with a thread containing Kevlar® fiber. FR-treated polyester seam tape was also used throughout.

All sleep sets were individually burned according to Technical Bulletin 603 of the State of California. All five had a Peak Heat Release Rate of less than 150 kilowatts in the first 30 minutes with a Total Heat Release of less than 25 megajoules in the first 10 minutes.

1. A single layer nonwoven fabric useful as a fireblocking component for mattresses comprising:
a) at least 0.5 ounces per square yard (17 grams per square meter) of a cellulose fiber that retains at least 10 percent of its fiber weight when heated in air to 700° C. at a rate of 20 degrees C. per minute,
b) at least 0.5 ounces per square yard (17 grams per square meter) of a organic fiber that retains 90 percent of its fiber weight when heated in air to 500° C. at a rate of 20 degrees C. per minute,
c) the fabric having a basis weight having at least 2.5 ounces per square yard (85 grams per square meter), a density of at least 0.16 gram/cm³, and an air permeability of 70 meters/min (225 ft/min) or less.

2. The fabric of claim 1 having a basis weight of from 2.5 to 7 ounces per square yard (85 to 237 grams per square meter).

3. The fabric of claim 2 wherein the organic fiber is a fiber comprising para-aramid polymer.

4. The fabric of claim 3 wherein the para-aramid is poly(p-phenylene terephthalamide).

5. The fabric of claim 2 wherein the cellulose fiber is a viscose fiber containing silicic acid.

6. The fabric of claim 1 wherein the single layer nonwoven fabric further comprises an off gassing material that releases a flame suppressing gas when burned.

7. The fabric of claim 6 wherein the off gassing material is a modacrylic fiber.

8. The fabric of claim 6 wherein the off gassing material is a polyvinylchloride fiber.

9. A fireblocked mattress comprising:
a) a mattress core,
b) a panel comprising a single layer nonwoven fireblocking fabric, and
c) ticking having a basis weight in the range of 2 to 8 ounces per square yard (68 to 271 grams per square meter),
the single layer nonwoven fabric comprising (i) at least 0.5 ounces per square yard (17 grams per meter) of a cellulose fiber that retains at least 10 percent of its fiber weight when heated in air to 700° C. at a rate of 20 degrees C. per minute, and (ii) at least 0.5 ounces per square yard (17 grams per meter) of an organic fiber that retains 90 percent of its fiber weight when heated in air to 500° C. at a rate of 20 degrees C. per minute, the fabric having a basis weight of at least 2.5 ounces per square yard (85 grams per square meter), a density of at least 0.16 gram/cm³, and an air permeability of 70 meters/min (225 f/min) or less.

10. The fireblocked mattress of claim 9 further comprising a border comprising the single layer nonwoven fabric.

11. The fireblocked mattress of claim 9 wherein the organic fiber is a fiber comprising para-aramid polymer.

12. The mattress of claim 11 wherein the para-aramid is poly(p-phenylene terephthalamide).

13. The mattress of claim 9 wherein the cellulose fiber is a viscose fiber containing silicic acid.

14. The mattress of claim 9 wherein the single layer nonwoven fabric further comprises an off gassing material that releases a flame suppressing gas when burned.

15. The mattress of claim 14 wherein the off gassing material is a modacrylic fiber.

16. The mattress of claim 14 wherein the off gassing material is a polyvinyichloride fiber.

17. The mattress of claim 9 wherein the continuous nonwoven fireblocking fabric comprises a seam sewn with fire resistant thread.

18. The mattress of claim 17 wherein the fire resistant thread comprises para-aramid or glass thread.

19. A process for fireblocking a mattress having a mattress core comprising:
providing the mattress core with a single layer nonwoven fabric useful as a fireblocking component for mattresses comprising:
a) at least 0.5 ounces per square yard (17 grams per meter) of a cellulose fiber that retains at least 10 percent of its fiber weight when heated in air to 700° C. at a rate of 20 degrees C. per minute, and
b) at least 0.5 ounces per square yard (17 grams per meter) of an organic fiber that retains 90 percent of its fiber weight when heated in air to 500° C. at a rate of 20 degrees C. per minute,
the fabric having a basis weight of at least 2.5 ounces per square yard (85 grams per square meter), a density of at least 0.16 gram/cm³, and an air permeability of 70 meters/min (225 fumin) or less.

20. The process for fireblocking the mattress of claim 19 wherein the organic fiber is a fiber comprising para-aramid polymer.

21. The process for fireblocking the mattress of claim 20 wherein the para-aramid is poly(p-phenylene terephthalamide).

22. The process for fireblocking the mattress of claim 19 wherein the cellulose fiber is a viscose fiber containing silicic acid.

23. The process for fireblocking the mattress of claim 19 wherein the single layer nonwoven fabric further comprises an off gassing material that releases a flame suppressing gas when burned.

24. The process for fireblocking the mattress of claim 23 wherein the off gassing material is a modacrylic fiber.

25. The process for fireblocking the mattress of claim 23 wherein the off gassing material is a polyvinylchloride fiber.
